(19) United States
(12) Patent Application Publication
(10) Pub. No.: US 2023/0307940 A1
(43) Pub. Date: Sep. 28, 2023

(54) OPTIMIZE AN ENERGY STORAGE SYSTEM OF PHOTO-VOLTAIC COUPLED WITH BATTERY

(71) Applicant: LT (USA) Corp., Edinburg, TX (US)

(72) Inventors: Geoffrey Wen-Tai Shuy, Taipei City (TW); Hsin-Chen Lai, Taichung (TW)

(21) Appl. No.: 18/325,862

(22) Filed: May 30, 2023

(51) Int. Cl. H02J 7/35; H02J 3/38; H02J 7/00; H02S 40/38

(52) U.S. Cl. CPC H02J 7/35; H02J 3/381; H02J 7/007182; H02S 40/38; H02J 2300/26

(57) ABSTRACT

A photo-voltaic (PV) battery system that includes a battery system, a photo-voltaic (PV) electricity generation system, and a charge controller. The battery system is configured to store electrical charge at a voltage V_{b} when fully charged. The photo-voltaic electricity generation system is configured to convert energy from incident light into electricity to thereby generate electricity. The charge controller is coupled to the battery system and the photo-voltaic electricity generation system so that at least some of the generated electricity flows through the charge controller into the battery system. For any given light intensity L within a practical solar intensity range, the electricity generated in the photo-voltaic system has a maximum power extraction voltage point Vₘₓ(L) and its corresponding current Iₘₓ(L). They are function of the incident light intensity L. The above referred charge controller; when designed in according with the principles described in this patent disclosure can set a power extraction voltage point Vₓ(L) with its corresponding current Iₓ(L) to extract and to store an amount of energy into the above referred battery; such that this stored energy amount is larger than the stored amount would be; when it is extracted at the Vₘₓ(L) and stored into the battery. While the (Vₓ(L)−V_{b})/(Vₘₓ(L)−V_{b}) is in between 20% and 95% for incident light intensity L within the practical solar light range. This fact and principles are described in detail in this patent disclosure.

### BACKGROUND

The photovoltaic effect is a process in which energy from a photon is used to generate a free electron. Photons are the fundamental particles (or waves) of light. Free electrons are the fundamental particles (or waves) of electricity. A photovoltaic cell is a component that uses the photovoltaic effect to generate electricity using energy from light such as sunlight. Such photovoltaic are often termed “solar cells”. A solar panel is a structure that includes one or more solar cells. A system that is capable of generating usable electricity using solar energy is often termed a photovoltaic (PV) system. PV systems that store some of the generated electricity are termed herein a PV battery system.

One type of conventional PV battery system consists of (1) a PV electricity generator (such as a solar panel), (2) a battery, (3) a controller, and (4) a load connected to the battery through a switch (or which is connected in parallel with the battery through another switch in the controller). The PV electricity generator converts the power of the incident solar rays to electrical current that charges the battery. The solar ray intensity at that moment is termed “the solar irradiance level” herein.

The subject matter claimed herein is not limited to embodiments that can solve any disadvantages or that operate only in environments such as those described above. Rather, this background is only provided to illustrate exemplary technology areas where some embodiments described herein may be practiced.

### BRIEF SUMMARY

In accordance with embodiments described herein, a photo-voltaic (PV) battery system includes a battery system, a photo-voltaic (PV) electricity generation system, and a charge controller. The battery system is configured to store electrical charge at a voltage V_{b} when fully charged. As an example, the battery system may be a single battery or multiple batteries. The voltage V_{b} may be, for example, a nominal voltage of the battery system, or in other words, a voltage of the battery system when the battery system is fully charged. The photo-voltaic electricity generation system is configured to convert energy from incident light into electricity to thereby generate electricity. As an example, the photo-voltaic electricity generation system may be one or more solar panels. The charge controller is coupled to the battery system and the photo-voltaic electricity generation system so that at least some of the generated electricity flows through the charge controller into the battery system. The voltage generated by the photo-voltaic electricity generation system is termed herein the “extraction voltage” (or Vₓ). The current generated by the photo-voltaic electricity generation system is termed herein the “extraction current” (or Iₓ).

Solar intensity levels typically range from a light intensity of 100 joules/sec/m² to 1000 joules/sec/m². This range will also be referred to herein as a “practical solar intensity range”. For any given light intensity L within the practical solar intensity range, the generated electricity generated by the photo-voltaic electricity generation system has a maximum power extraction voltage point Vₘₓ(L) that is a function of light intensity L, and has a maximum power extraction current point Iₘₓ(L) that is also a function of light intensity L.

However, the charge controller is configured such that, for at least some of the light intensities L within the practical solar intensity range, the extraction current Iₓ(L) is greater than the maximum power extraction current point Iₘₓ(L) and the extraction voltage Vₓ(L) is less than the maximum power extraction voltage point Vₘₓ(L) and above the voltage V_{b} of the battery system. As an example, the extraction current Iₓ(L) may be configured to be within the current plateau region (defined further below) of the current-voltage (I-V) curve of the photo-voltaic electricity generation system. For the reasons described below, this results in more efficient charging of the battery system, as compared to extracting at the maximum power extraction voltage point Vₘₓ(L).

This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features can be obtained, a more particular description of various embodiments will be rendered by reference to the appended drawings. Understanding that these drawings depict only sample embodiments and are not therefore to be considered to be limiting of the scope of the invention, the embodiments will be described and explained with additional specificity and detail through the use of the accompanying drawings in which:

FIG. 1: symbolically depicts two I-V characteristics and P-V characteristics diagrams of a typical PV subsystem under (high/low) two solar intensity levels;

FIG. 2 symbolically depicts an I-V characteristics and P-V characteristics diagram of the MPPT charging practice;

FIG. 3: symbolically depicts an I-V characteristics and P-V characteristics diagram of the PV subsystem: under the same solar intensity level of that in FIG. 2;

FIG. 4 is a block diagram which symbolically shows a controller in a typical commercial PV-battery system using MPPT charging practice;

FIG. 5 is a block diagram which symbolically shows a passive controller in the MESP, with its connecting subsystems;

FIG. 6 is a block diagram which symbolically shows a passive controller set up in the MESP, with its connecting subsystems; and

FIG. 7 is a block diagram which symbolically shows an active controller set up in the MESP, with its connecting subsystems.

### DETAILED DESCRIPTION

In accordance with embodiments described herein, a photo-voltaic (PV) battery system includes a battery system, a photo-voltaic (PV) electricity generation system, and a charge controller. The battery system is configured to store electrical charge at a voltage V_{b} when fully charged. As an example, the battery system may be a single battery or multiple batteries. The voltage V_{b} may be, for example, a nominal voltage of the battery system, or in other words, a voltage of the battery system when the battery system is fully charged. The photo-voltaic electricity generation system is configured to convert energy from incident light into electricity to thereby generate electricity. As an example, the photo-voltaic electricity generation system may be one or more solar panels. The charge controller is coupled to the battery system and the photo-voltaic electricity generation system so that at least some of the generated electricity flows through the charge controller into the battery system. The voltage generated by the photo-voltaic electricity generation system is termed herein the “extraction voltage” (or Vₓ). The current generated by the photo-voltaic electricity generation system is termed herein the “extraction current” (or Iₓ).

Solar intensity levels typically range from a light intensity of 100 joules/sec/m² to 1000 joules/sec/m². This range will also be referred to herein as a “practical solar intensity range”. For any given light intensity L within the practical solar intensity range, the generated electricity generated by the photo-voltaic electricity generation system has a maximum power extraction voltage point Vₘₓ(L) that is a function of light intensity L, and has a maximum power extraction current point Iₘₓ(L) that is also a function of light intensity L.

However, the charge controller is configured such that, for at least some of the light intensities L within the practical solar intensity range, the extraction current Iₓ(L) is greater than the maximum power extraction current point Iₘₓ(L) and the extraction voltage Vₓ(L) is less than the maximum power extraction voltage point Vₘₓ(L) and above the voltage V_{b} of the battery system. As an example, the extraction current Iₓ(L) may be configured to be within the current plateau region (defined further below) of the current-voltage (I-V) curve of the photo-voltaic electricity generation system. For the reasons described below, this results in more efficient charging of the battery system, as compared to extracting at the maximum power extraction voltage point Vₘₓ(L).

The MPPT Charging, VS, the MESP Charging Practices:

During a charging stage, the battery system is being charged. That is, at least some of the electricity generated by the photo-voltaic electricity generation system is extracted through the charge controller to charge the battery system. The terminal voltage of the battery system during the charging stage is termed herein as “the charging voltage” (or V_{c}). The charging voltage V_{c} is lower than the extraction voltage Vₓ because the voltage of the extracted electricity decreases as the electricity passes through the charge controller. The voltage difference between the extraction voltage Vₓ and the charging voltage V_{c} is termed herein “the dissipation voltage”.

After this charging stage, the controller can discharge the battery system to power a load. During the discharging stage, the nominal voltage V_{b} of the battery is applied to the load. The difference between the charging voltage V_{c} and the nominal voltage V_{b} is termed herein “the charge/discharge voltage difference”. The above definitions will be used hereinafter unless otherwise specified.

The maximum power extraction voltage point Vₘₓ(L) is defined as the voltage that one can extract maximum electric power from a photo-voltaic electricity generation system. This well-known definition misleads typical system designers of commercial solar street lamps. That is, typical designers of commercial PV battery systems falsely think and/or thought that by extracting electricity at the maximum power extraction voltage point Vₘₓ(L) for any given license intensity L; one would store the most amount of photo-voltaic energy into the battery system for that light intensity L.

Therefore, conventional charge controllers use a boost module to actively specify the maximum power extraction voltage point Vₘₓ(L) of the photo-voltaic electricity generation system as the extraction voltage Vₓₜ(L) at any momentary light intensity level L. Then, the conventional design uses a buck module to actively reduce the voltage to around a voltage named as “the battery charging voltage” (V_{bc}) (with a corresponding “battery charge current” I_{bc}) to charge and to protect the battery system. Notice also that the battery charging current V_{bc} is larger than the nominal voltage V_{b} of the battery system, but smaller than the extraction voltage Vₓₜ.

The inventors have discovered that this Maximum Power Point Tracking (MPPT) charging practice is suboptimal for a number of reasons. First, the MPPT charging practice does not match the characteristics of the energy production device (the photo-voltaic device) to effectively and efficiently extract the produced energy for storage into the battery system. Second, the MPPT charging practice does not match the device that performs the extraction, to prepare and deliver the extracted energy for efficient charging of the battery system. Third, the energy storage efficiency of the battery system is not solely dependent on the power production, but also depends on energy storage and the final energy utilization. Fourth, the typical instantaneous power storage into the battery system is not equal to the instantaneous power produced by the photo-voltaic electricity generation system, even when complying with the energy and charge conservation laws. Such power storage must also comply with the Kirchhoff's laws.

If conventional designers believe that following the MPPT charging practice is simply the best approach, the designers have no need or incentive to experimentally determine the effectiveness and efficiencies of the various devices, such as the effectiveness and efficiency of energy production and extraction from the photo-voltaic device, and such as the effectiveness and efficiency of energy that is prepared and then delivered to the battery system.

In accordance with the principle described herein the controller efficiency of a system is the termed its “energy storage efficiency”. In this description and in the claims, the instantaneous “energy storage efficiency” is defined as the instantaneous energy stored into the battery system divided by the instantaneous maximum power generated by the photo-voltaic electricity generation system. In a preferred embodiment, this instantaneous value is measured in a condition that holds the solar primary power input and the battery system steady for a long enough period of time such that the values of the power generated, the power storage, and the ratio have all reached steady state.

Without indicating how the relevant efficiency is measured experimentally, providers of commercial MPPT charging practice typically proclaim greater than 90% efficiency for their system's controller in capturing and storing the produced photo-voltaic energy. However, the inventors' experimental measurements of many commercial MPPT charging systems reveal that the efficiency of energy extraction from the photo-voltaic device (and that of preparing and then storing the energy into battery system) can be very poor when regulating the system operation to simply conform to the MPPT charging practice. A typical controller that implements the MPPT charging practice can have efficiencies typically below 50% even when advertised to be very high.

Herein described is, in some embodiments, a system in which the extraction voltage Vₓ is set within a voltage range that is within a current plateau region (defined later) of the photo-voltaic electrical generation system. In accordance with the principles described herein, a controller actively and/or passively adjusts the charging voltage according to the instantaneous solar intensity level at that moment, such that the extraction voltage Vₓ stays within a voltage range that is within the current plateau region of the photo-voltaic electricity generation system for solar intensities in the practical solar intensity range that is between 100 and 1000 joule/sec/m². By so doing, the charge controller effectively stores an energy larger than that of the MPPT charging practice. This charging practice is named as “the MESP” charging practice”, or “the MESP” herein.

A PV battery system includes a battery system, a photo-voltaic (PV) electricity generation system, and a charge controller. A load is connected to the battery system through a switch. Alternatively, the load can be connected in parallel with the battery system through another switch in the controller. The parallel connection of the load and the battery system through a switch configuration can stabilize the PV battery system's power supply amongst having other benefits.

The principles of operation of the voltage module do not depend on whether the load is connected to the battery system through a switch, or whether the load is connected in parallel with the battery system through the switch. Accordingly, this detail description herein will omit the description of the parallel connection of the load and battery system herein. This detail description will focus on a part of the controller which is termed “the voltage module” herein. This voltage module controls the extraction voltage Vₓ from the photo-voltaic electricity generation system; and also controls the charging voltage V_{c} to the battery system.

In accordance with the principles described herein, an active voltage module, or a passive voltage module of the charge controller controls the extraction voltage Vₓ and the battery charging voltage V_{c}; such that the extraction voltage Vₓ is within the voltage range of the current plateau region of the photo-voltaic electricity generation system under the practical solar intensity range of from 100 to 1000 joules/sec/m².

In doing so, under (1) the same solar light intensity history and (2) the same charging duration time; the MPPT charging practice would store less energy into the battery system than the technology described herein could as will now be explained.

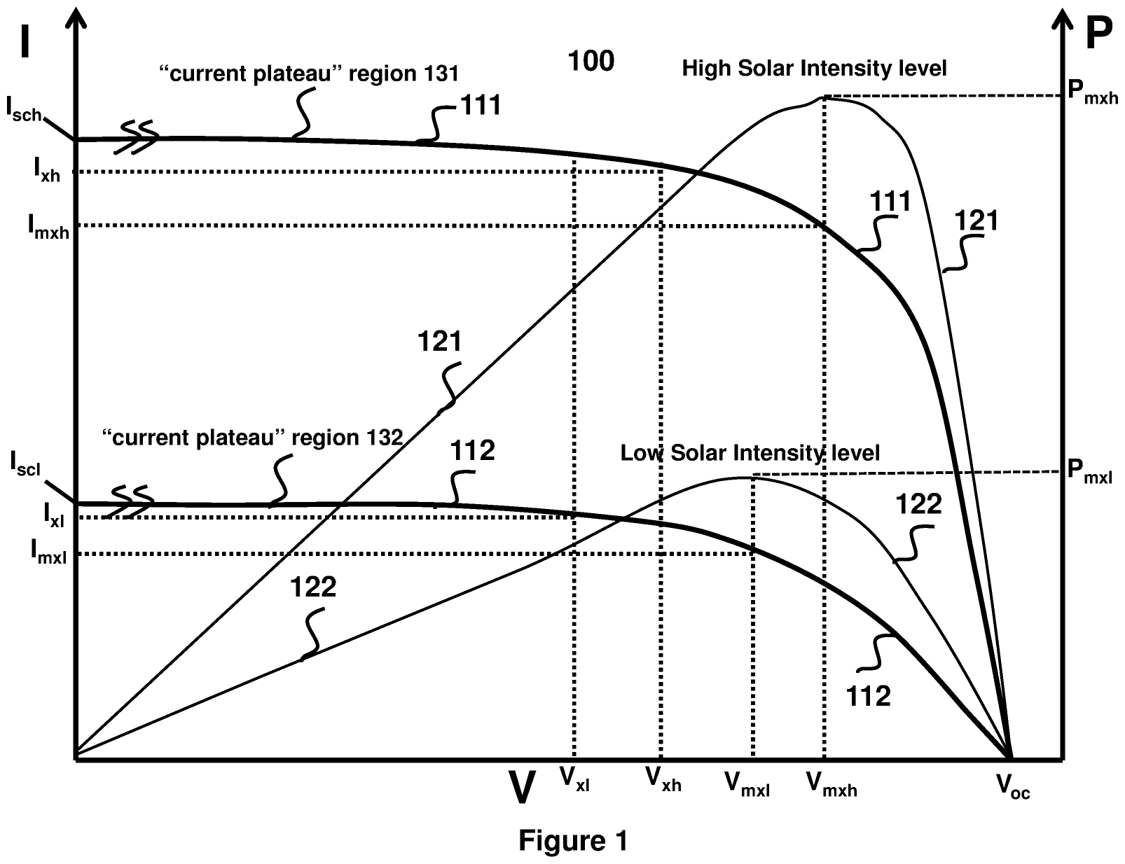

FIG. 1 illustrates a diagram 100 that shows two I-V curves 111 and 112, and two PV curves 121 and 122 that show typical I-V characteristics and PV characteristics of a typical photo-voltaic electricity generation system. The horizontal axis represents the voltage V of the electricity generated by the photo-voltaic electricity generation system. The I-V curves 111 and 112 are plotted with respect to current I on the left vertical axis, which current levels are labelled to the left and represent the current of the electricity generated by the photo-voltaic electricity generation system. The PV curves 121 and 122 are plotted with respect to power P on the right vertical axis, which power levels are labelled to the right and represent the power of the electricity generated by the photo-voltaic electricity generation system.

The curve 111 represents the I-V characteristics of the photo-voltaic electricity generation system at a higher solar light intensity level, and the curve 112 represents the I-V characteristics of the photo-voltaic electricity generation system at a lower solar intensity level. The curve 121 represents the PV characteristics of the photo-voltaic electricity generation system at a high solar light intensity level, and the curve 122 represents the PV characteristics of the photo-voltaic electricity generation system at a lower solar intensity level.

The voltage Vₘₓₕ is the voltage level at the maximum power point (Vₘₓ) of the photo-voltaic electricity generation system under the high solar intensity level. The voltage Vₘₓₗ is the voltage level at the maximum power point (Vₘₓ) of the photo-voltaic electricity generation system under the low solar intensity level. The current Iₘₓₕ is the current level when the voltage is at Vₘₓₕ under the high solar intensity level; and the current Iₘₓₗ is the current level is at Vₘₓₗ under the low solar intensity levels

Each of the IV curves 111 and 112 has a respective current plateau region. For instance, the I-V curve 111 corresponding to the high solar intensity level has a current plateau region 131, and the I-V curve 112 corresponding to the low solar intensity level has a current plateau region 132. Notice that the corresponding current values (Iₘₓₕ or Iₘₓₗ) of either solar intensity levels are notably smaller than their current plateau values at their high/low sunshine levels respectively. Thus, we clearly define “the current plateau region” herein.

In this description and in the claims, a current plateau region with respect to an I-V curve is that portion of the I-V curve in which the absolute value of the slope of the I-V curve is less than or equal to 0.1 amps/volts. That is a current plateau region with respect to an IV curve is that portion of the I-V curve in which the absolute value of dI/dV is less than or equal to 0.1 amps/volts. In contrast, in this description and in the claims, a foothill region with respect to an I-V curve is that portion of the I-V curve in which the absolute value of dI/dV is greater than or equal to 0.5 amps/volt. In this description and in the claims, a knee region is a region that is between the current plateau region and the foothill region and it that portion of the I-V curve in which the absolute value of dI/dV is between 0.1 and 0.5 amps/volt. Thus, the current plateau region of an I-V curve is the relatively flat portion of the I-V curve.

Toward the larger voltage value of these two current plateau regions 111 and 112 in FIG. 1, there are two respective voltage points (Vₓₗ and Vₓₕ) depicted as the example extraction voltages of the principles described herein at low solar intensity level and high solar intensity level, respectively. As depicted, the current value at voltage Vₓₕ is Iₓₕ; and the current value at the voltage Vₓₗ is Iₓₗ.

These current values (Iₓₕ and Iₓₗ) at the current plateau regions 132 and 131 are greater than the respective current values (Iₘₓₕ and Iₘₓₗ) at their maximum voltage points under same solar intensity levels. Accordingly, when using the principles herein, for any given solar intensity level, the extracted current for that solar intensity level is larger than the extracted current when using the MPPT charging practice for that solar intensity level.

Of course, the amount of energy stored in a battery system is roughly proportional to the time integral of the current charging to the battery. As illustrated above, the current of a MESP charging practice for the battery system is extracted at its current plateau region. Thus, the extraction current value Iₓ is higher than the current value Iₘₓ at its MPPT voltage Vₘₓ. One can conclude from the above illustrations that: at any solar intensity level, the instantaneous energy storage into the system in the MESP practice will be more than that of the MPPT charging practice.

Thus it can be also concluded: at the same solar intensity history and the same charging duration time length, the MESP charging practice can store more energy into the battery system than the MPPT charging practice. The detail in the difference of MPPT charging practice and the MESP charging practice will now be described.

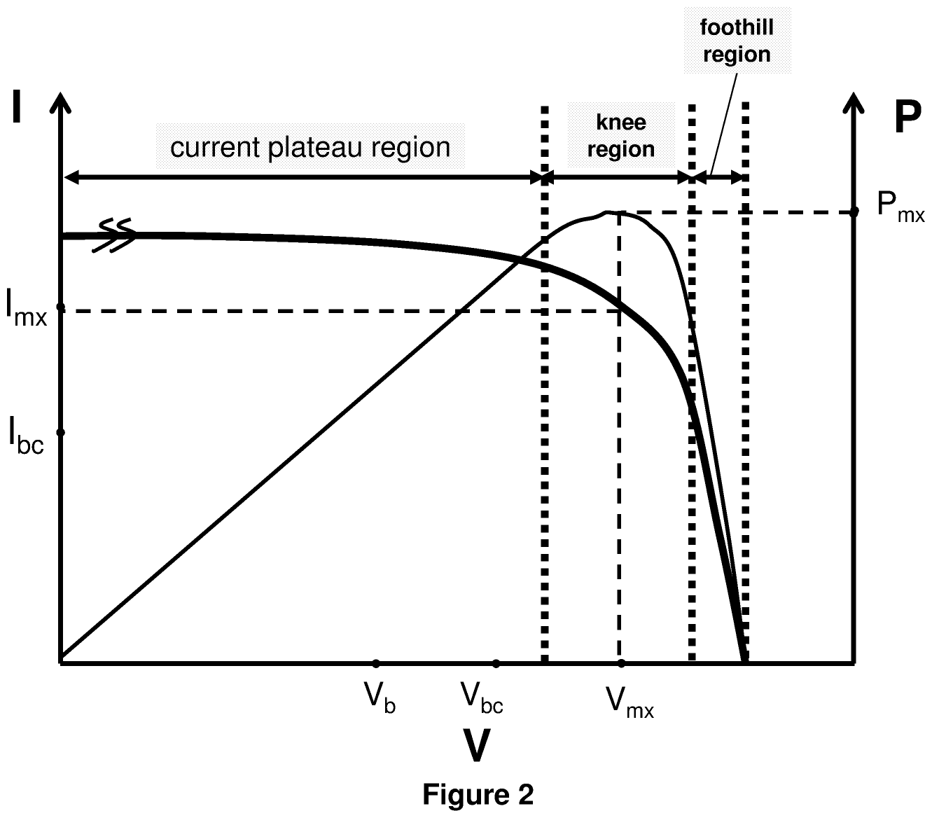

I-V characteristics and P-V characteristics of a typical photo-voltaic electricity generation system that is under a practical solar intensity level is symbolically illustrated in FIG. 2. The voltage Vₘₓ depicted in FIG. 2 is the voltage point at the maximum power point of the PV. The current Iₘₓ is the current value at Vₘₓ. The voltage after the adjustment of the controller (which includes a boost module followed by a buck circuit) is V_{bc}. The current value at this controller's output is I_{bc}. Notice that the value of the charging current I_{bc} is typically smaller than the current Iₘₓ for the reasons described below.

When a boost circuit specifies the input voltage/current (Vₘₓ/Iₘₓ); then its output voltage Vₜₓ is larger than Vₘₓ, but its output current Iₜₓ is smaller than Iₘₓ. Furthermore, when an input voltage of the extraction voltage Vₜₓ is adjusted by a buck circuit to be a smaller output voltage of V_{bc}, then its output current (I_{bc}) is smaller than its input current Iₜₓ. Lastly, this output current I_{bc} is equal to the input current Iₜₓ multiplied by the ratio of the output to input voltage (V_{bc}/Vₜₓ); in other words, I_{bc}=Iₜₓ*(V_{bc}/Vₜₓ).

A boost circuit characteristically demands that the output voltage Vₜₓ be larger than its input voltage Vₘₓ; and that the output current Iₜₓ be smaller than its input Iₘₓ. Furthermore, a buck circuit characteristically demands that its output voltage V_{bc} be always smaller than its input voltage Vₜₓ, which is the output voltage of the previous BOOST circuit series connected. Accordingly, the output/input voltage ratio of V_{bc}/Vₜₓ is smaller than one (1). Therefore, the output current of the buck circuit I_{bc} must be smaller than the extraction current of the boost circuit Iₜₓ. One can derive from above that Iₘₓ>Iₜₓ>I_{bc}. In other words, the charging current I_{bc} is definitely smaller than the current Iₘₓ. This is a definitive result of a boost module being series connected a buck module.

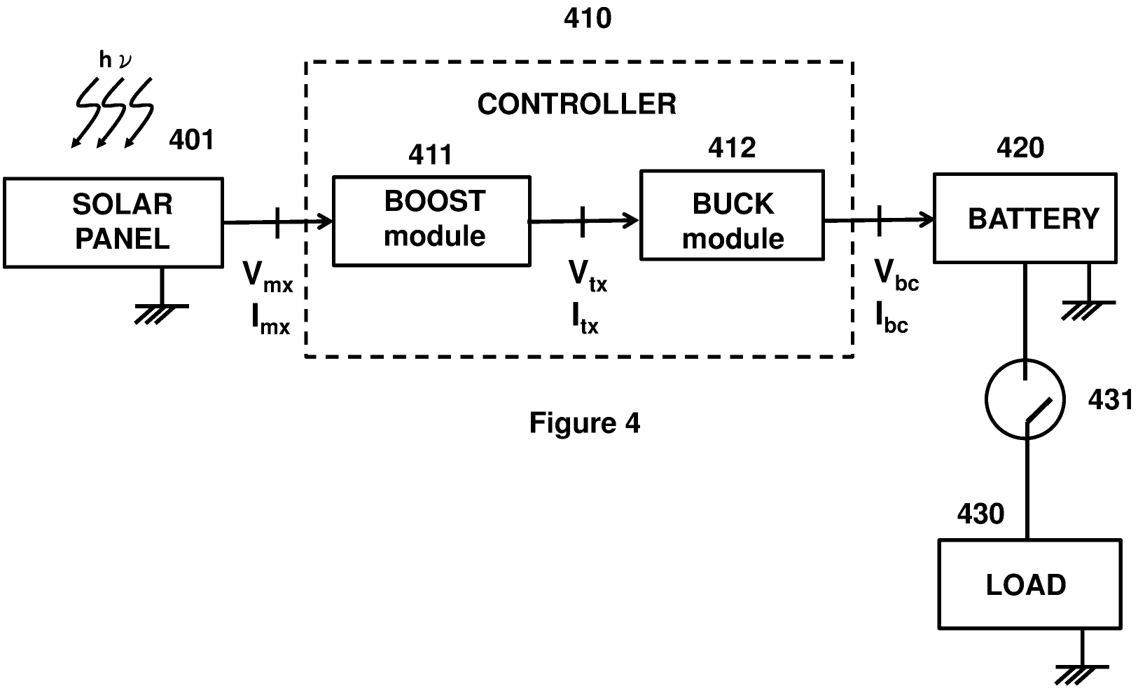

The commercial products are configured as above described; as depicted in FIG. 4. It consisted of at least one solar panel series 401 connected with a controller 410 that includes one boost module series 411 connected with one buck module 412. This is also series connected with one battery 420. The electricity at voltage Vₘₓ and current Iₘₓ) generated by the solar panel 401 is provided as input to the boost module 411. The voltage Vₜₓ and current Iₜₓ is the output from the boost module 411 and is provided as input to the buck module 412. Electricity having voltage V_{bc} and current I_{bc} is the output from the buck module 412 to charge the battery 420. A load 430 is connected via a switch 431 to the battery 420.

To conclude from the above illustrations: At the same solar intensity level, (1) the value I_{bc} (the MPPT charging current) is smaller than Iₘₓ; also (2) the Iₘₓ is smaller than current value at its current plateau. In other words, the charge current value of the MESP, which is in the current plateau region, is always greater than the current at maximum voltage (Iₘₓ) which is also greater than the charging current (I_{bc}) of the MPPT charging practice.

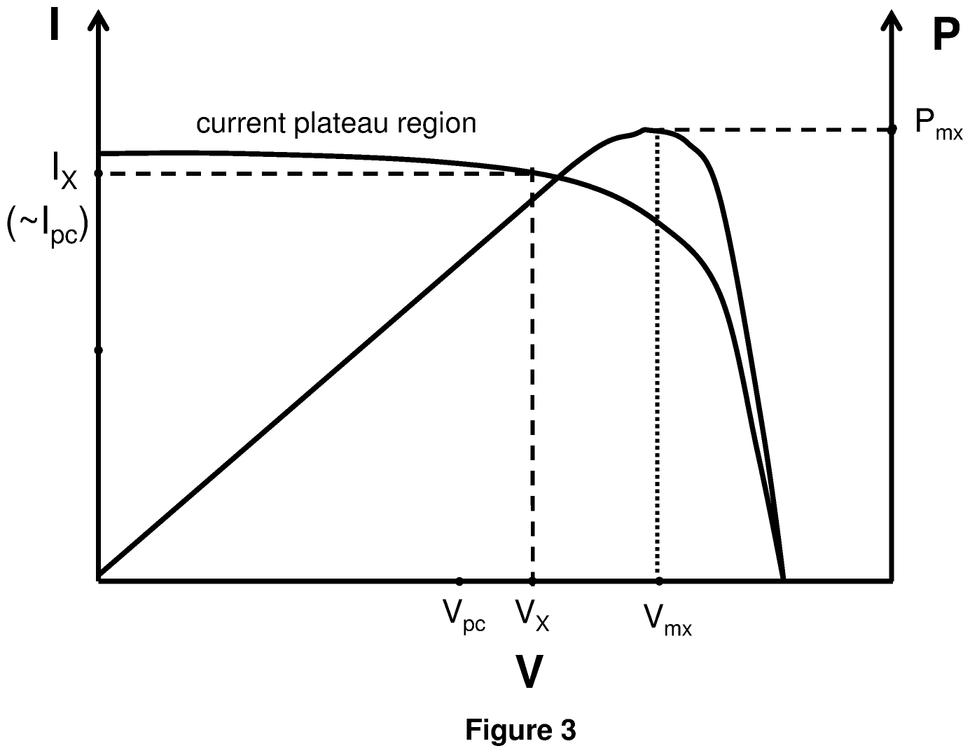

Diagrams I-V characteristics and PV characteristics of a PV subsystem are symbolically illustrated in FIG. 3. FIG. 3 also illustrates an example of the extracting voltage (Vₓ) specified by a design in accordance with the MESP. The characteristics of the extraction voltage Vₓ is that (1) the voltage corresponds to a current that is in the current plateau region, (2) the extraction voltage Vₓ is above the nominal battery voltage V_{b} and, (3) the extraction voltage Vₓ is lower than the Vₘₓ, as shown in FIG. 3.

Please be reminded of the above conclusions that: the current value of MESP charging is at the current plateau region and is greater than the current at maximum voltage (Iₘₓ) which is also greater than the charging current I_{bc} of the MPPT charging practice. At this current plateau region, the extraction voltage point Vₓ, is actively or passively adjusted to the MESP charging voltage V_{pc} and current I_{pc}, these (active/passive) controllers will be described in the embodiments later.

Notice that the values Vₓₚ and Iₓₚ are referred to as the extraction voltage and current of MESP. As will be described later; the active/passive adjustment device (a Vₓ module of the controller) is designed to have a charging current in the MESP practice I_{pc} under any practical sunshine is always larger than that of the Iₘₓ. In other words, the currents I_{pc}>Iₘₓ>I_{bc}; and therefore the MESP can store more energy than that of the MPPT charging in any instance, under any practical sunshine level.

To compare the differences between the MPPT charging practice and the MESP; we conducted two experiments as follows: both experiments are under a standard light source, simulating the highest practical solar intensity level. The two energy store systems both consist of a photo-voltaic panel with Vₘₓ=33 volts, and a battery with its nominal voltage V_{b}=24 volts. But one experiment is with a commercial controller of which is using MPPT charging practice, while the other experiment is using a MESP's designed controller.

In one experiment, just as a typical commercial product that use the MPPT charging practice; a boost module was used to extract the photo-voltaic power at its maximum power voltage point that measured Vₘₓ=33 volts. The output voltage of the boost module was measured to be 41 volts. After this boost module, a buck module was used to regulate voltage down to 27 volts to charge the battery. The measured current at Vₘₓ=33 volts was 10 amps. The current after the buck adjustment was measured to be I_{bc}=8.2 amps to charge the battery.

In the other experiment, the inventors used a controller which is designed using the principles of the MESP charging practice to extract its energy at Vₓₚ at its current plateau region. The measured extraction voltage Vₓₚ was 27 volts (which is near and above the nominal storage voltage V_{b}=24 volts). Its corresponding current value Iₓₚ was measured to be 11.4 amps. After Vₓₚ was reduced by the controller, the charging voltage V_{pc} was measured near 26.7 volts; and the measured charge current (I_{pc}) was 11.4 amps.

These measured parameters in the above described two experiments clearly confirmed the above stated conclusions: I_{pc}>Iₘₓ>Iₜₓ>I_{bc}. Therefore, the MESP practice would charge more electricity than would the MPPT charging practice. From the above experiments, the resulting charging current ratio of the MPPT charging practice gives 8.2 amps charging while MESP gives 11.4 amps charging. Please be reminded that, the instantaneous storage power of any battery system is equal the current flow through the battery system multiplied by its nominal voltage. Accordingly, the MESP charging practice would give 11.4/8.2=1.39 times more current; about 40% more energy (power) storage than that of the MPPT charging practice.

After finished the above experiment that used 1000 joules/sec/m² photo ray intensity, the same experiments were repeated for different light intensity levels including (1) 750 joules/sec/m², (2) 500 joules/sec/m², (3) 250 joules/sec/m², (4) 100 joules/sec/m². In all the 4 repeats, the battery charging currents of the MESP charging practice were all greater than that of the MPPT charging practice. Therefore, one can conclude that the MESP charging practice results in a practical optimization method for the PV-battery energy storage system under any practical solar intensity history and charging duration.

### Embodiment I: Design and Connection Steps of the MESP Passive Controller

The maximum current of a solar panel set (occurring under short circuit conditions) under a standard light simulating the maximum sun shine intensity on earth surface is referred to as I_{scx} herein. The maximum terminal voltage under the same conditions of a solar panel set (but which occurred under open circuit conditions) is referred to as V_{ocx} herein. Notice that the voltage V_{ocx} is the largest terminal voltage amount all terminal voltages in practical operations of this solar panel set; and the current I_{scx} is the largest current value amount all current values during practical operation of this solar panel set.

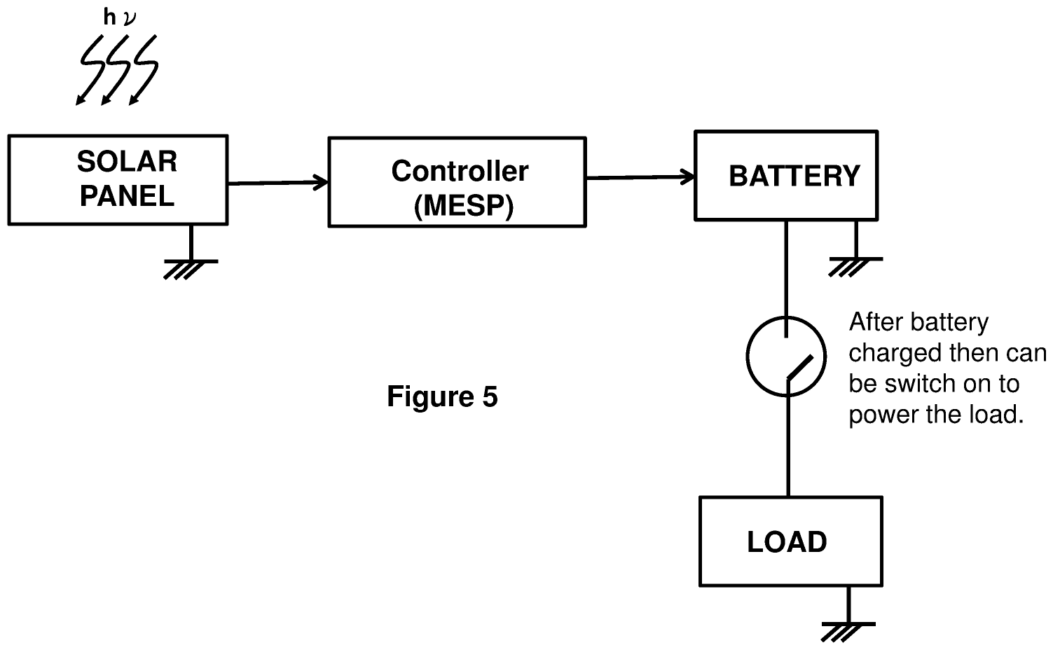

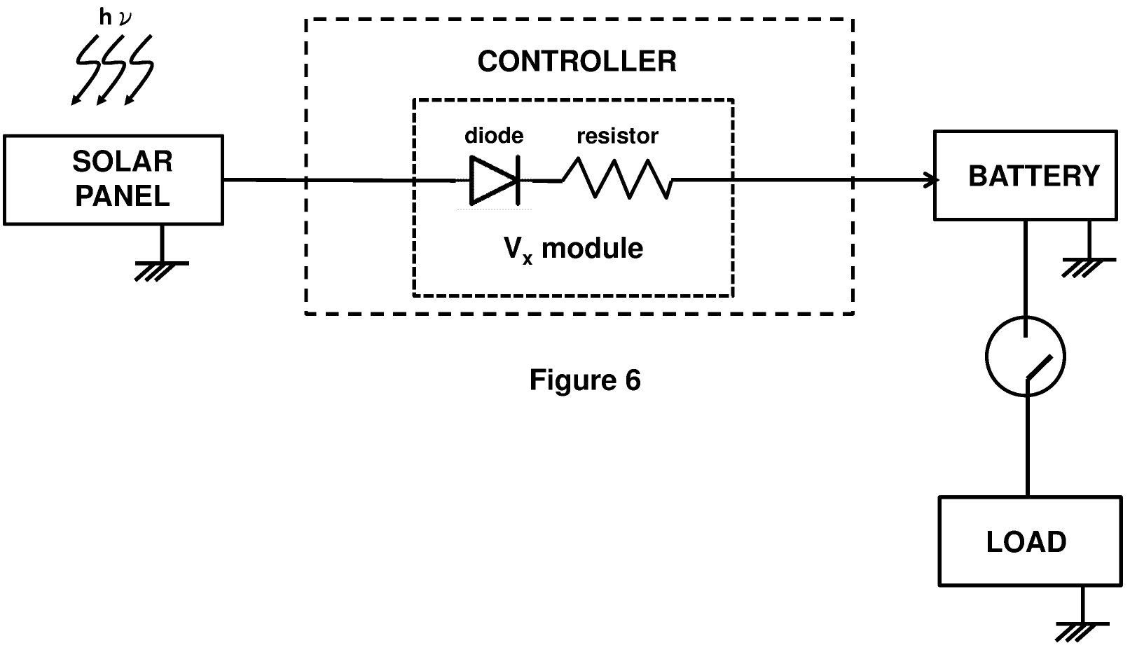

The practical steps of designing and connection steps an MESP controller are described in the followings: (A) First step, one matches the subsystems, the solar panel with Vₘₓ, the battery with nominal voltage V_{b}, and the load with its terminal voltage Vii: Under a standard light source that simulates the maximum solar intensity on earth, a solar panel is chosen which has its Vₘₓ>V_{b}+5 volts (or more but ideally not more than 12 volts); and Vₗₜ=V_{b} (more or less). (B) Second step, one chooses a diode with its voltage rating Vᵣ>two time of the V_{ocx}, that is 2*V_{ocx} (or more) and with its current rating Iᵣ>three times of the I_{scx}, that is 3*I_{scx} or more; and also with its forward voltage V_{fw}<1.0 Volt. Diodes fulfill these specifications are commercially available. The factors 2, 3 are safety factors of the ratings for the diode protection. (C) Third step, one chooses a resistor R having resistance value (referred to as R_{cnt} herein) such that when multiplied with the current I_{scx} would give a little bit more than 2 volts, i.e. I_{scx}*R_{cnt}>2.x, while x is less than 4. This resister R has a power rating of bigger than three times of I_{scx} multiplied by the dissipation voltage (defined above), 3*I_{scx}*(the dissipation voltage). These specifications would ensure that the extraction voltage Vₓ is always in the current plateau region at any practical solar intensity. (D) Fourth step, series connect the above diode and the resister to form an extraction voltage control module, or “the extraction module”, or “the Vₓ module” (referred hereinafter) of the designed controller which may contain other modules. This module controls the extraction voltage which is ensured to be always in the current plateau region of the solar panel set, while the other modules performs other design functions for the controller. (E) Fifth step, connecting the diode end of this Vₓ module to the solar panel set, while connects the resister end to the battery; as depicted in FIG. 6. Thus one finished the design and connection of the MESP controller. Notice that the direction of current flow through is allowed to charge the battery from the solar panel, but inhibit current flow to the solar panel. The resister R of the controller also performs a current limiting role. The load shall be connected to the battery terminals through a switch to regulate it power flow needs. This connection is symbolically depicted in FIG. 5.

The specified extraction voltage point Vₓ can be set at a value in between the value of the nominal voltage of the battery, V_{b}, and the voltage value of maximum power point of the PV that is under the practical maximum sunshine intensity (1000 jule/sec/m²). This voltage value is named as the Vₘₘₓ herein. The percentage ratio of |(Vₓ−V_{b})| value and the (Vₘₘₓ−V_{b}) value is named as the percentage of the charging voltage drop herein. This charging voltage drop percentage can be designed to be 5% up to 80%.

However, this passive energy charging mechanism can not specify the extraction voltage freely. Designers of passive controller do not have any freedom to choose the extraction voltage point.

### Embodiment II: Design of an Active Controller for the MESP

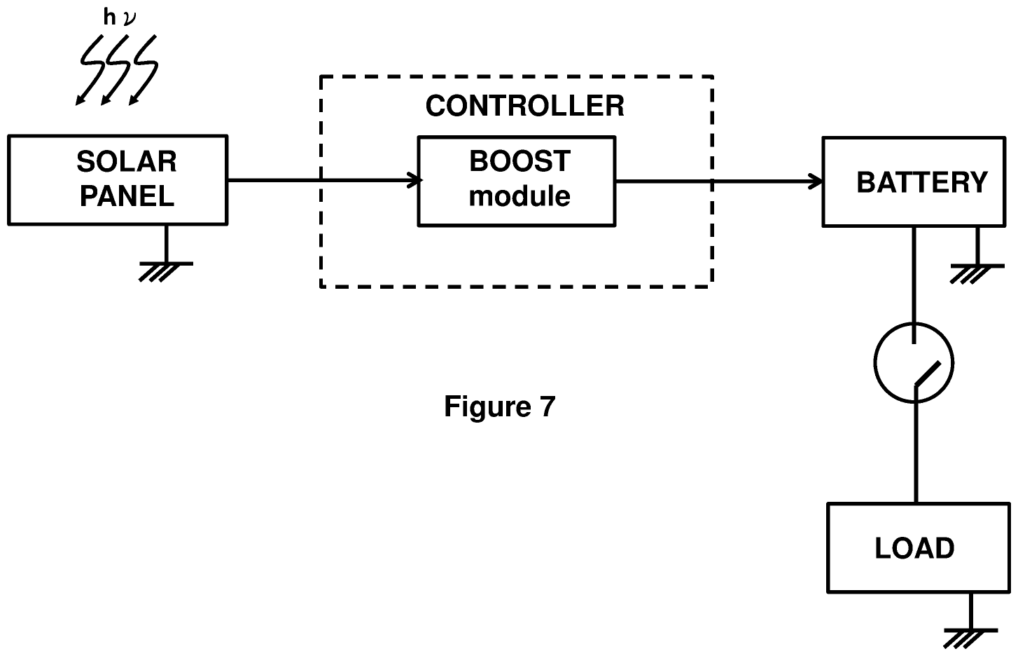

An active controller for the MESP charging practice can be designed to specify the voltage of energy extraction point Vₓ that is always inside the voltage range of the current plateau region of the solar panel which is under the practical solar intensity level by using a boost module; as depicted in FIG. 7. It is well known in the art that the input and output of a boost circuit can be specified as the extraction voltage Vₓ and the charging voltage V_{pc} which are always inside a specified voltage range, including in the voltage range of the current plateau region of the solar panel; as long as its input voltage is sufficiently smaller than output voltage. When specifies the output voltage V_{pc} at the voltage range of the current plateau region, any smaller input voltage Vₓ would be surely in the voltage range of that current plateau region. Therefore, when choosing the charging voltage V_{pc} inside the range of the nominal voltage V_{b} and V_{b}+3 volts; and choosing the solar panel with its Vₘₓ to be above V_{b}+5 volts; as specifies in the step (A) of the previous embodiment I, the corresponding current of the charging current I_{pc} can be bigger than that of the MPPT practice (a bigger current than the Iₘₓ at Vₘₓ voltage). This results in greater energy storage charging of the battery system.

The specified extraction voltage point Vₓ can be set at a value in between the value of the nominal voltage of the battery, V_{b}, and the voltage value of maximum power point of the PV that is under the practical maximum solar intensity (1000 joule/sec/m²). This voltage value is named as the Vₘₘₓ herein. The percentage ratio of | (Vₓ−V_{b})| value and the (Vₘₘₓ−V_{b}) value is named as the percentage of the charging voltage drop herein. This charging voltage drop percentage can be designed to be 5% up to 80%.

This active energy charging mechanism can specify the extraction voltage. Designers of active controller do have freedom to choose a specified extraction voltage point that having higher charging current. This voltage point can be ether below the V_{b} or above the V_{b}; however it must be remain within the voltage domain of the current plateau region of the PV.

### Conclusion

The above descriptions show the principle described herein, the MESP can surely design a voltage extraction module of the MESP controller that actively/passively assures that the extraction voltage value Vₓ will be always at the voltage range of the current plateau region of the solar panel which is under the practical solar intensity level. This assures the MESP charging current I_{pc} would be bigger than the current (Iₘₓ) at the Vₘₓ voltage point. Of course, the higher value of the time integral of the charging current would result in a higher storing energy into the battery. Therefore, the MESP charging practice results in a practical improvement for the energy storage system with the same solar intensity history and the same charging history.

1. A system comprising:
a battery system configured to store electrical charge at a voltage V_{b} when fully charged;
a photo voltaic electricity generation system configured to convert incident light into electricity to thereby generate electricity having a maximum power extraction voltage point Vₘₓ(L) and a maximum power extraction current point Iₘₓ(L) for any given light irradiance level L within a range of light irradiance range from 100 joules/sec/m² to 1000 joules/sec/m²; and
a charge controller coupled to the battery system and the photo voltaic electricity generation system so that at least some of the generated electricity flows through the charge controller into the battery system, the charge controller configured to extract the at least some of the generated electricity such that, for at least some of the light irradiance levels L within the light irradiance range from 100 joules/sec/m² to 1000 joules/sec/m², the extraction current Iₓ(L) is greater than the maximum power extraction current point Iₘₓ(L) and the extraction voltage Vₓ(L) is less than the maximum voltage point Vₘₓ(L) and above the voltage V_{b} of the battery system.

2. The system in accordance with claim 1, the charge controller configured such that for all of the light irradiance levels L within the light irradiance range, the extraction current Iₓ(L) is greater than the maximum power extraction current point Iₘₓ(L) and the extraction voltage Vₓ(L) is less than the maximum voltage point Vₘₓ(L) and above the voltage of the battery system.

3. The system in accordance with claim 1, the charge controller configured such that (Vₓ(L)−V_{b})/(Vₘₓ(L)−V_{b}) is between 20 percent and 95 percent for at least some of the light intensities L within the range.

4. The system in accordance with claim 1, the charge controller configured such that (Vₓ(L)−V_{b})/(Vₘₓ(L)−V_{b}) is between 20 percent and 95 percent for all of the light intensities L within the range.

5. An energy storage system of photo-voltaic (PV) coupled with battery, the energy storage system comprising:
at least one electricity generation unit;
at least one solar panel;
at least one energy storage including a battery;
at least one controller;
at least one load connected to the battery through a first switch; or parallel connected with the battery through a second switch that performs another function during battery charging, wherein the solar panel converts the shining photon ray into electricity to then charge the energy storage unit, with a nominal voltage V_{b}, through the controller;
wherein at the practical sun shine intensity (1000 to 100 joules/sec/m²) the controller specifies an energy extraction voltage point Vₓ; then through the controller actively or passively adjust the extracted voltage to a suitable charging voltage V_{pc} for charge and protect the battery;
wherein under the practical sun shine intensity, the designed controller is configured to actively or passively maintain the charging voltage above V_{b}; but the Vₓ always stays in the voltage range of the current plateau region of the solar panel; and Vₓ is smaller than the maximum power extraction voltage point Vₘₓ with a same sun shine intensity; such that the charging current I_{pc} is always larger than that of Iₘₓ, the current at Vₘₓ.

6. The energy storage system of claim 5, further comprising a series connection of one diode with one resister; the diode being to direct the current flows into the battery while the resister acting as a charging current limiter that protects the battery.

7. The energy storage system of claim 5, further comprising a BOOST circuit that actively specifies its input and output voltage to be the an energy extraction voltage Vₓ and the charging voltage V_{pc} such that these two voltages are always maintained inside the region of the current plateau voltage range of the solar panel which is under a practical sun shine level.

8. The energy storage system of claim 7, the energy extraction voltage (Vₓ) being below the V_{b}, but remaining within the voltage domain of the current plateau region in the I-V characteristics of the PV.

9. The energy storage system of claim 1, the energy extraction voltage (Vₓ) being above the V_{b}, but remaining within the voltage domain of the current plateau region in the I-V characteristics of the PV.

10. The energy storage system of claim 5, the charging voltage drop percentage with respect to the Vₘₓ(L) being more than 5% but less than 10%.

11. The energy storage system of claim 5, the charging voltage drop percentage with respect to the Vₘₓ(L) being more than 10% but less than 25%.

12. The energy storage system of claim 5, the charging voltage drop percentage with respect to the Vₘₓ(L) being more than 25% but less than 50%.

13. The energy storage system of claim 5, the charging voltage drop percentage with respect to the Vₘₓ(L) being more than 50% but less than 70%.
